(19) United States
(12) Patent Application Publication
(10) Pub. No.: US 2002/0002616 A1
(43) Pub. Date: Jan. 3, 2002

(54) Method and apparatus for providing multimedia service in network environment

(76) Inventor: Hyon Chang Lim, Sungnam (KR)

Correspondence Address: BIRCH, STEWART, KOLASCH & BIRCH, LLP, P.O. Box 747, Falls Church, VA, 22040-0747, US

(21) Appl. No.: 09/750,215

(22) Filed: Dec. 29, 2000

(30) Foreign Application Priority Data
Dec. 31, 1999 (KR) 68078/1999

(51) Int. Cl. G06F 15/16; G06F 15/173

(52) U.S. Cl. 709/227; 709/226

(57) ABSTRACT

A method for providing a multimedia service in a network environment, in which a server and a plurality of clients are connected with each other and the server provides a multimedia service according to a request of a client, includes: a service requesting step in which one of the plurality of clients requests a multimedia service from the server; a capability negotiation step in which it is evaluated whether the service is to generate a session to provide a multimedia service according to a request by one of the clients; and service providing step in which the server provides a multimedia service to one of the clients through the capability negotiation. A session acceptable to the server can be generated while not affecting a session in service through the capability negotiation. Therefore, the quality of the session can be guaranteed, and the resource of the server and the network are fully utilized in providing a multimedia service.

### BACKGROUND OF THE INVENTION

1. Field of the Invention

The present invention relates to a multimedia service method and apparatus in a network environment, and more particularly, to a method and apparatus for providing a multimedia service in a network environment which is capable of providing stably a high quality multimedia service through a capability negotiation which evaluates resources of a server, a network bandwidth and a a client.

2. Description of the Background Art

A conventional network service employs a session method in which a server provides information to each client through a communication path on a network, upon receiving requests from the clients. Since it is utilized on the basis of texts, there is not much demand for a service quality.

However, as the communication capability of computers is being developed and extended, a world wide web comes on stage and a network service provides a multimedia service such as a motion picture.

Accordingly, a computer network becomes massive in size and complicated, causing problems that the capacity of its network communication path is limited due to increase in traffic and the hosts has been saturated in number, resulting in that a better multimedia service quality is hardly guaranteed for users on the network.

FIG. 1 illustrates a multimedia system in a network environment in accordance with a conventional art.

As shown in the drawing, there are shown clients 2, 4 and 6 requesting and using a multimedia service in a network environment, and a server 10 for providing a multimedia service in the network environment.

The server 10 generates a session according to requests from the clients 2, 4 and 6, and the clients 2, 4 and 6 are provided with a multimedia service through a competition for predetermined sessions.

However, since the resources constructing a computer system such as a memory, a CPU or a network band width of the server are limited, which leads to a limitation to the sessions with which the server 10 may provide the clients

In other words, since the server 10 accepts clients as many as predetermined sessions, even though the clients 2, 4 and 6 are provided with a multimedia service from the server 10 through a competition, generation of a new session would affect the service quality of the existing sessions, resulting in that a quality of a multimedia service is not guaranteed on the network.

FIG. 2 illustrates a multimedia system in a network environment in which sessions are limited in number

As shown in the drawing, the server 20 generates a session according to requests from the clients 12, 14, 16 and 18, and the clients are provided with a service through a competition for as many as predetermined sessions. Since the number of the sessions acceptable to the server 20 is previously determined, in case that a new service request is reached from a client while the server is providing a predetermined session for service, the server refuses to accept it.

That is, for example, on the assumption that the number of clients that can be available to be accepted by the server is ‘n’ clients, the server refuses to accept a service request of ‘n+1th’ client.

However, since a service is provided to as many as the predetermined clients (that is, as many as ‘n’ number) without evaluating capability of the server, even though there is a room available for the resources constructing the computer system such as the memory, the CPU or the network bandwidth in the server, since the server accepts only the clients as many as predetermined number of sessions, its capability is not fully utilized.

### SUMMARY OF THE INVENTION

Therefore, an object of the present invention is to provide a method for providing a multimedia service in a network environment which is capable of guaranteeing a stable multimedia service quality and effectively using elements of a network to fully utilize resources of a server, a network bandwidth and a client.

To achieve these and other advantages and in accordance with the purpose of the present invention, as embodied and broadly described herein, there is provided a method for providing a multimedia service in a network environment including: a service request step in which one of a plurality of clients requests a multimedia service; and a capability negotiation step in which a server accepts the request from the client and evaluates resources of the client and a network as well as its own resources to determine whether a session is to be newly generated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a multimedia system in a network environment in accordance with a conventional art;

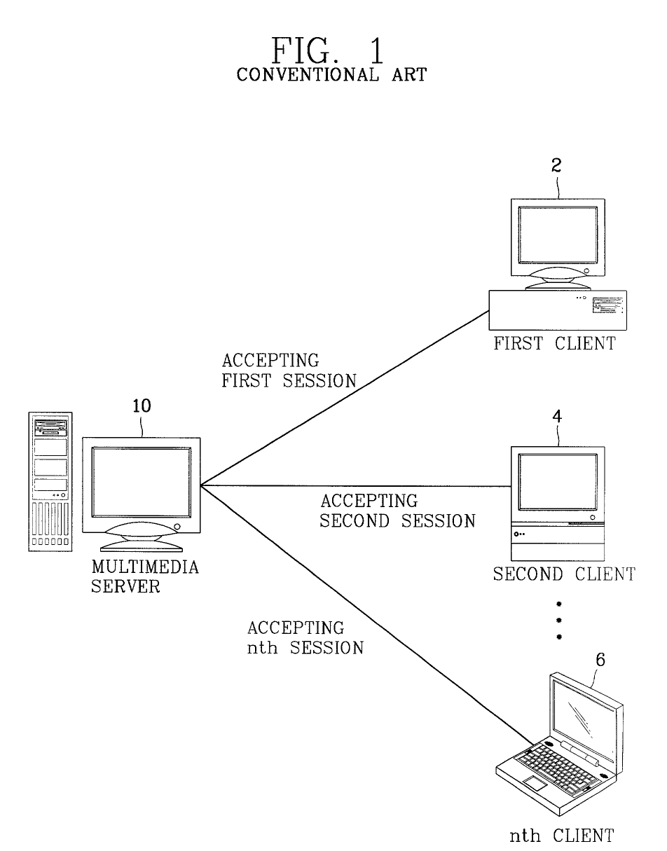

FIG. 2 illustrates a multimedia system in the network environment in which the number of sessions is limited in accordance with the conventional art;

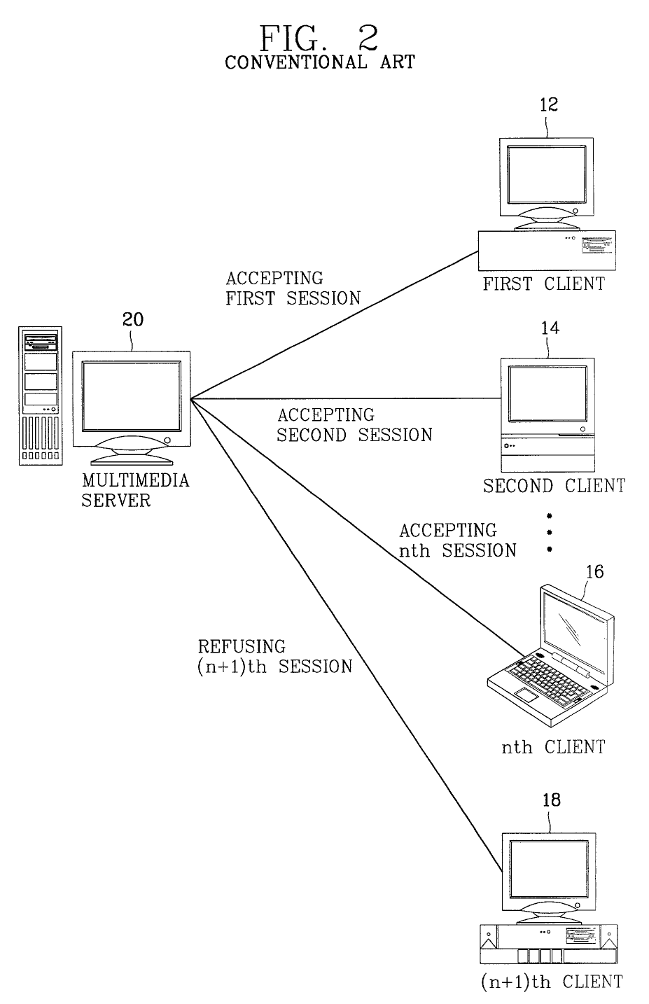

FIG. 3 is a block diagram illustrating a capability negotiation of a method for providing a multimedia service in a network environment in accordance with the present invention; and

FIG. 4 is a flow chart of the capability negotiation of the method for providing a multimedia service in the network environment in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

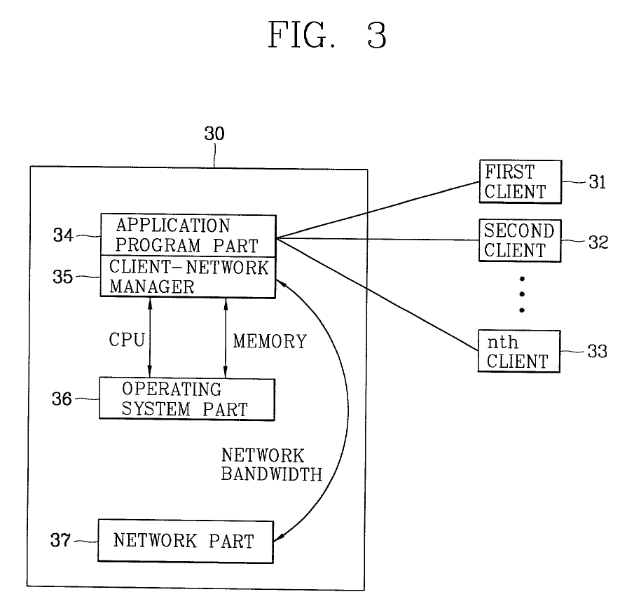

FIG. 3 is a block diagram illustrating a capability negotiation of a method for providing a multimedia service in a network environment in accordance with the present invention, which includes clients 31 and 32 that are being received a multimedia service from a server 30 in a network environment, a client 33 which requests a multimedia service from the server 30 in the network environment, and the server 30 for providing a multimedia service to clients on the network.

The server 30, including an application program part 34, an operating system 36 and a network part 37, provides a text or a multimedia service to the clients.

The application program part 34 includes a client-network manager 35 and provides an information service supporting an application processing procedure of a user.

The operating system 36, providing a service required for the application program part 34 to use a hardware and a software, serves to make a CPU scheduling, allocate and retrieve a memory unit.

The network part 37 serves to establish, maintain, terminate a connection between systems, to input and output a data, and to manage address assignment, a path selection and a network function selection.

The operation in the capability negotiation constructed as described will now be explained.

First, when the client 33 requests a multimedia service from the server 30 in the network environment, the server 30 determines the resource use amount according to the multimedia service form requested by the client and then evaluates the resources such as its own CPU or a memory, the bandwidth of a network being currently used and a CPU or a memory of the client 33 to determine whether a session is to be newly generated.

In detail, the client-network manager 35 of the application program part 34 checks the resource allocation amount with respect to the CPU and the memory from the operating system 36, checks the resource allocation amount with respect to the network bandwidth from the network part 37, and checks the resource allocation amount with respect to the CPU and the memory of the client.

In other words, in case that the resources such as the CPU, the memory and the network bandwidth are available to use, the server 30 generates a session, while in case that the resources are not available to use, the server refuses to generate a session.

Accordingly, the without necessity of previously determining the number of sessions, the multimedia service can be effectively provided to the client on the network with the maximum number of sessions according to the operating situation of the server.

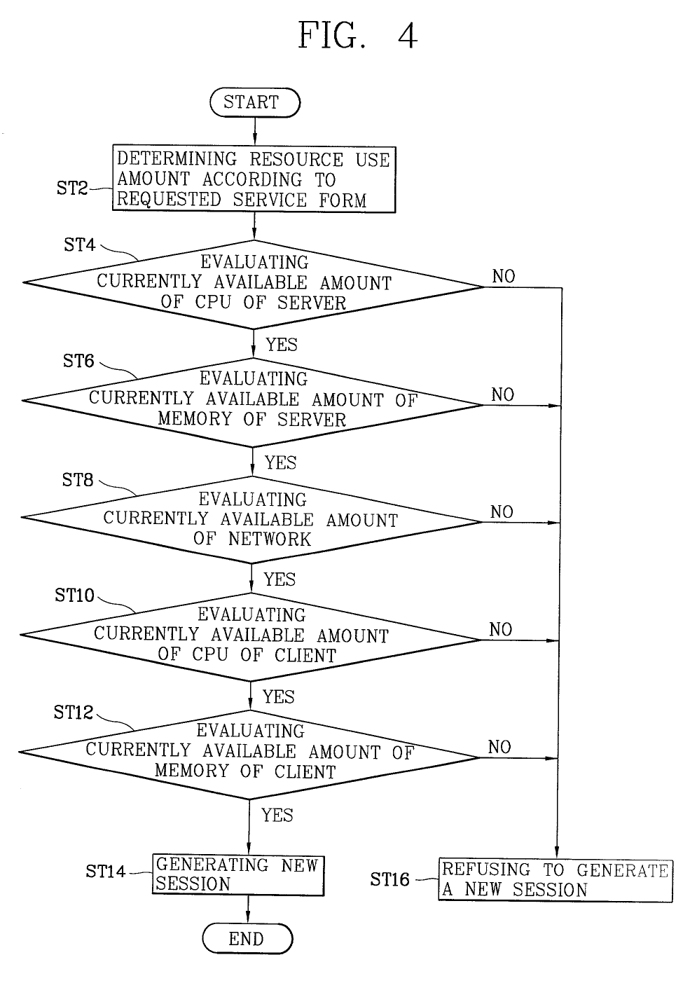

FIG. 4 is a flow chart of the capability negotiation of the method for providing a multimedia service in the network environment in accordance with the present invention.

As shown in the drawing, the capability negotiation of the present invention includes a step of evaluating resources of the server, the step of evaluating resources of a network, and a step of evaluating resources of a client.

First, the server determines the resource use amount of such as the CPU, the memory or the network bandwidth. That is, in case that the form of the service requested by the client with the server is a text, a resource allocation amount is small, while, in case that the form of the service requested by the client with the server is a multimedia, a resource allocation amount is large.

When the server determines the resource allocation amount (ST2), the server evaluates a currently available amount of the CPU thereof to check whether the resource allocated in the server is receivable (ST4).

In case that the resource allocated in the CPU of the server is currently receivable, the server evaluates a currently available amount of the memory thereof to check whether the resource allocated in the server is receivable (ST6).

In case that the resource allocated in the memory of the server is receivable, the server evaluates a currently available amount of the bandwidth of the network, to check whether the resource allocated in the network bandwidth is receivable (ST8).

In case that the resource allocated in the network bandwidth is receivable to the server, the server evaluates a currently available amount of the CPU (ST10) and of the memory (ST12) of the client, to check whether a requested service is acceptable.

In case that the allocated resources are all receivable in the steps of ST4 through ST12, the server generates a new session (ST14).

Meanwhile, in case that the allocated resources are not receivable even in one step of the steps ST4 through ST12, the server refuses to generate a new session (ST16).

That is, the capability negotiation signifies that the server measures the resources of itself, the resources of the network and the resources of the client, based on which the server dynamically determines whether a service is to be provided or not.

Accordingly, without necessity of previously determining the number of the sessions, the server can effectively provide a multimedia service at the maximum of the sessions according to the operating situation of itself in the network environment.

As so far described, according to the method and apparatus for providing a multimedia service in a network environment of the present invention, a session acceptable to the server can be generated while not affecting a session in service through the capability negotiation. Therefore, the quality of the session can be guaranteed, and the resource of the server and the network are fully utilized in providing a multimedia service.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A method for providing a multimedia service in a network environment in which a server and a plurality of clients are connected with each other and the server provides a multimedia service according to a request of a client, comprising:
a service requesting step in which one of the plurality of clients requests a multimedia service from the server;
a capability negotiation step in which it is evaluated whether the service is to generate a session to provide a multimedia service according to a request by one of the clients; and
service providing step in which the server provides a multimedia service to one of the clients through the capability negotiation.

2. The method according to claim 1, wherein the capability negotiation step comprising the sub-steps of:
evaluating an available amount of a CPU and a memory of the server;
evaluating an available amount of a bandwidth of a network;
evaluating an available amount of a CPU and a memory of a client; and
generating a new session in case that the resources of the client and the network are available after being evaluated.

3. The method according to claim 2, wherein, in the capability negotiation step, in case that even one of the server, the client and the network is short of resources, a new session is refused to be generated.

4. An apparatus for providing a multimedia service in a network environment in which a server and a plurality of clients are connected with each other and the server provides a multimedia service according to a request of a client, comprising:
one of a plurality of clients who requests a multimedia service from a server; and
a server for determining whether a session is to be generated to provide the multimedia according to the request of the client.

5. The apparatus according to claim 4, wherein the server comprising:
an application program part for providing an information service supporting an application processing procedure of a user;
an operating system for providing a service required for the application program part to use a hardware and a software; and
a network part for establishing, maintaining, terminating of a connection, and managing of address assigning, path selecting and network function selecting.

6. The apparatus according to claim 4, wherein the server provides a text or a multimedia data to a client.

7. The apparatus according to claim 4, wherein the server evaluates an available amount of resources such as a CPU and a memory of itself, a network bandwidth, and a CPU and a memory of the client, and in case that the resources are available to use, the server generates a new session, while in case that even one of the resources are not available to use, the server refuses to generate a new session.

8. The apparatus according to claim 5, wherein the application program part includes a client-network manager to check the resource allocation amount with respect to the CPU and the memory from the operating system 36, check the resource allocation amount with respect to the network bandwidth from the network part 37, and check the resource allocation amount with respect to the CPU and the memory of the client.
